(19) United States
(12) Patent Application Publication
(10) Pub. No.: US 2024/0095190 A1
(43) Pub. Date: Mar. 21, 2024

(54) DEVICE MANAGEMENT SYSTEM CAPABLE OF MANAGING DEVICES

(71) Applicant: KYOCERA Document Solutions Inc., Osaka (JP)

(72) Inventors: Tomoki OYASATO, Osaka (JP); Tetsuyuki CHIMURA, Osaka (JP); Takuma FUJITA, Osaka (JP)

(73) Assignee: KYOCERA Document Solutions Inc., Osaka (JP)

(21) Appl. No.: 18/244,519

(22) Filed: Sep. 11, 2023

(30) Foreign Application Priority Data
Sep. 20, 2022 (JP) 2022-149015

(51) Int. Cl. G06F 13/10

(52) U.S. Cl. CPC G06F 13/10; G06F 2213/40

(57) ABSTRACT

A device management system according to an aspect of the present disclosure is a device management system capable of managing a device and includes a control device that includes a processor and functions, through the processor executing a control program, as a device management page creator and a connection status confirmer. The device management page creator creates a device management page that is a Web page for managing the device. The connection status confirmer confirms a connection status of the device to the device management system. When a specific request relating to the device management page is made, the connection status confirmer confirms the connection status of the device subject to the device management page.

### INCORPORATION BY REFERENCE

This application claims priority to Japanese Patent Application No. 2022-149015 filed on Sep. 20, 2022, the entire contents of which are incorporated by reference herein.

### BACKGROUND

The present disclosure relates to device management systems capable of managing devices.

A device management system capable of managing devices is known. For example, a multifunction peripheral is connected to a LAN, thus being capable of connecting to the Internet through a firewall. The firewall prohibits breaking into the LAN from the outside and allows, even as for communications from the inside to the outside of the LAN, only communications over a specific protocol (for example, the HTTP protocol). There is known a technique in which, for example, in the event of a failure in a multifunction peripheral, the multifunction peripheral notifies a management server of the occurrence of the failure by doing data communication over a protocol (the HTTP protocol) allowed by a firewall.

### SUMMARY

A technique improved over the aforementioned technique is proposed as one aspect of the present disclosure.

A device management system according to an aspect of the present disclosure is a device management system capable of managing a device and includes a device-side control device that includes a processor and functions, through the processor executing a control program, as a device management page creator and a connection status confirmer. The device management page creator creates a device management page that is a web page for managing the device. The connection status confirmer confirms a connection status of the device to the device management system. When a specific request relating to the device management page is made, the connection status confirmer confirms the connection status of the device subject to the device management page.

### BRIEF DESCRIPTION OF THE DRAWINGS

FIG. 1 is a block diagram of a system according to an embodiment of the present disclosure.

FIG. 2 is an operation sequence diagram of the system in FIG. 1 when a Web browser displays a device management page.

FIG. 3 is a sequence diagram of connection status confirmation processing shown in FIG. 2.

### DETAILED DESCRIPTION

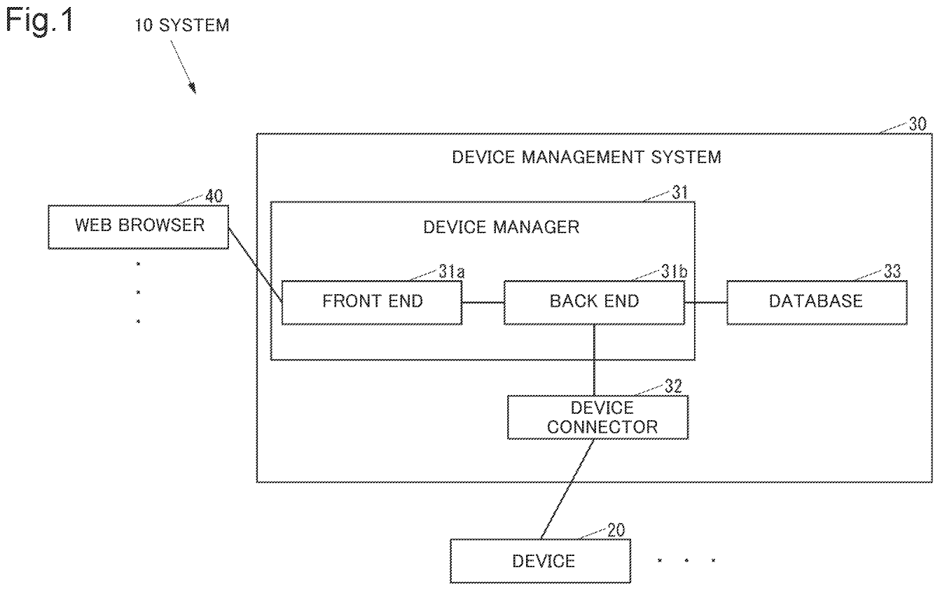

Hereinafter, a description will be given of a device management system 30 according to an embodiment as an aspect of the present disclosure with reference to the drawings. First, the configuration of a system 10 according to an embodiment of the present disclosure will be described. FIG. 1 is a block diagram of the system 10 according to this embodiment.

As shown in FIG. 1, the system 10 according to this embodiment at least includes a device management system 30, a device 20, and a Web browser 40. The system 10 includes at least one device 20 having the same configuration. For example, the system 10 can include one million devices. The device 20 included in the system 10 is formed of, for example, an image forming apparatus, such as an MFP (multifunction peripheral) or a dedicated printing machine. The device 20 included in the system 10 is connected to a network, such as a LAN (local area network), managed by an end user of the device 20.

The system 10 includes the device management system 30 that manages the device 20 in a remote location. The device management system 30 is implemented by at least one computer. The device management system 30 is implemented by the computer executing a program. The device management system 30 is implemented, for example, by a cloud computing service, such as Azure (registered trademark) by Microsoft (registered trademark). The device management system 30 can be used, for example, by the vendor, stores, and end users of the device 20. The device management system 30 is, for example, a system for providing various types of information to the user of the device management system 30 and making various settings for the device 20, such as an upgrade of firmware of the device 20.

The device management system 30 includes a device manager 31 that manages the device 20. For example, the device manager 31 restarts the device 20. The device manager 31 performs remote maintenance on the device 20, including making various settings for the device 20 and acquiring specific information on the device 20 from the device 20, such as information on toner in the device 20, counter information on the device 20, and error information on the device 20. The device manager 31 includes a front end 31a and a back end 31b. The device manager 31 is implemented, for example, by a Web server.

The front end 31a creates a Web page for managing the device 20 (hereinafter, referred to as a “device management page”). The front end 31a constitutes a device management page creator.

The back end 31b confirms the connection status of the device 20 to the device management system 30. The back end 31b constitutes a connection status confirmer.

The device management system 30 includes a device connector 32 to which the device 20 is to be connected. The device connector 32 is a cloud computing platform and is implemented, for example, by an Azure IoT Hub.

The device management system 30 includes a database 33 as a connection status holding device that holds various types of information, for example, the connection status of the device 20 to the device management system 30. The connection status of the device 20 to the device management system 30 is: an on-line status indicating that the device 20 is connected to the device connector 32 of the device management system 30; or an off-line status indicating that the device 20 is not connected to the device connector 32 of the device management system 30.

The device management system 30 includes a control device. The control device is made up by including a processor, a RAM (random access memory), a ROM (read only memory), and a dedicated hardware circuit. The processor is, for example, a CPU (central processing unit), an ASIC (application specific integrated circuit) or an MPU (micro processing unit).

When the processor operates in accordance with a control program stored in the above ROM or others, the control device functions as the device manager 31 including the front end 31a and the back end 31b. Alternatively, the front end 31a and the back end 31b can be each formed of a hardware circuit, instead of the operation of the control device in accordance with the control program. Hereinafter, the same applies to other embodiments unless otherwise stated.

The system 10 includes a Web browser 40 implemented by a computer, such as, for example, a PC (personal computer). Likewise, the system 10 may include, except for the Web browser 40, any web browser implemented by a computer. The user of the device management system 30 can access the device management system 30 via the Web browser 40. The Web browser 40 includes a processor, such as a CPU, and provides processing for performing a function as the Web browser 40 when the processor executes a control program.

Next, a description will be given of the operation of the system 10 when the Web browser 40 displays a device management page.

The following description is given by taking, as the operation of the system 10 when the Web browser 40 displays a device management page, for example, the operation of the system 10 when the Web browser 40 displays a device management page for the device 20.

The device management page for the device 20 contains the connection status of the device 20 to the device management system 30. Specific operations for the device 20, including, for example, an operation for restarting the device 20 and an operation for acquiring setting values for the device 20, are input via the Web browser 40 to the device management page for the device 20.

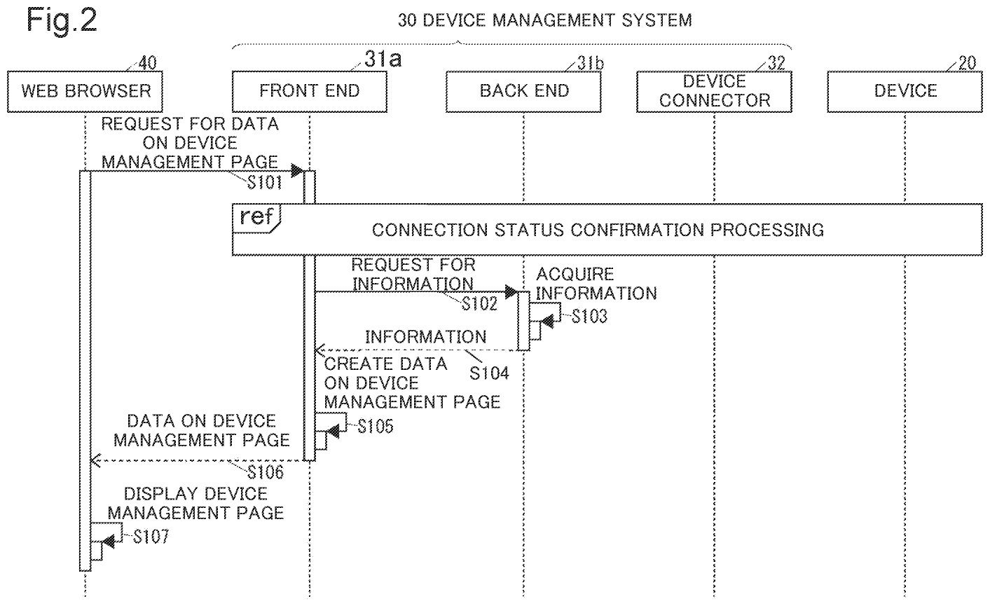

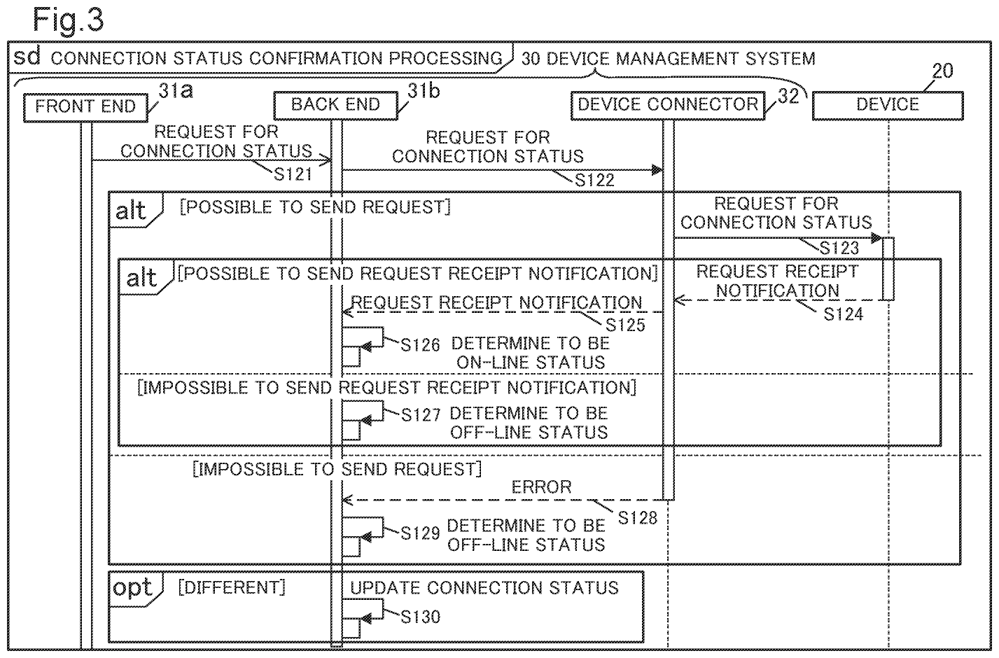

FIG. 2 is an operation sequence diagram of the system 10 when the Web browser 40 displays a device management page for the device 20. FIG. 3 is a sequence diagram of connection status confirmation processing shown in FIG. 2.

When an operation for displaying a device management page for the device 20 is input, for example, by the user of the device management system 30, the Web browser 40 sends, as shown in FIGS. 2 and 3, a request for data on the device management page for the device 20 to the front end 31a of the device manager 31 (S101).

When receiving the request in S101, the front end 31a sends to the back end 31b a request for the connection status of the device 20 to the device management system 30 (S121).

When receiving the request in S121, the back end 31b sends to the device connector 32 the request for the connection status of the device 20 to the device management system 30 (S122).

When the device connector 32 receives the request in S122 and can send to the device 20 the request for the connection status of the device 20 to the device management system 30, the device connector 32 sends to the device 20 the request for the connection status of the device 20 to the device management system 30 (S123).

When the device 20 receives the request in S123 and can send to the device connector 32 a request receipt notification for notifying that the device 20 has received the request for the connection status of the device 20 to the device management system 30, the device 20 sends the request receipt notification to the device connector 32 (S124).

When receiving the request receipt notification in S124, the device connector 32 sends the request receipt notification to the back end 31b of the device manager 31 (S125).

When receiving the request receipt notification in S125, the back end 31b determines that the connection status of the device 20 to the device management system 30 is an on-line status (S126).

When the device 20 receives the request in S123 but cannot send the request receipt notification to the device connector 32 for some reason, the device 20 does not send the request receipt notification to the device connector 32. Therefore, the device connector 32 also does not send the request receipt notification to the back end 31b of the device manager 31. When a specific period of time has elapsed without receiving the request receipt notification or a below-mentioned error from the device connector 32 after the end of the processing in S122, the back end 31b determines that the connection status of the device 20 to the device management system 30 is an off-line status (S127).

When the device connector 32 receives the request in S122 but cannot send to the device 20 the request for the connection status of the device 20 to the device management system 30, the device connector 32 sends an error to the back end 31b of the device manager 31 (S128).

When receiving the error in S128, the back end 31b determines that the connection status of the device 20 to the device management system 30 is an off-line status (S129).

When, after the end of the processing in S126, S127 or S129, the connection status of the device 20 to the device management system 30 determined in S126, S127 or S129 is different from the connection status of the device 20 to the device management system 30 held in the database 33, the back end 31b updates the connection status of the device 20 to the device management system 30 held in the database 33 with the connection status of the device 20 to the device management system 30 determined in S126, S127 or S129 (S130).

When the processing in S121 ends, the front end 31a sends to the back end 31b a request for information necessary to create a device management page for the device 20 (S102). Here, the information necessary to create a device management page for the device 20 contains the connection status of the device 20 to the device management system 30 as well.

When receiving the request in S102, the back end 31b acquires from the database 33 information necessary to create a device management page for the device 20 (S103).

When the processing in S103 ends, the back end 31b sends the information acquired in S103 to the front end 31a (S104).

When receiving the information in S104, the front end 31a creates, based on the received information, data on a device management page for the device 20 (S105).

When the processing in S105 ends, the front end 31a sends the data created in S105 to the Web browser 40 (S106).

When receiving the data in S106, the Web browser 40 displays, based on the received data, a device management page for the device 20 on a display device of the computer realizing the Web browser 40 (S107). The device management page for the device 20 contains the connection status of the device 20 to the device management system 30.

When the connection status of the device 20 to the device management system 30 has been updated in S130, but the acquisition of information from the database 33 in S103 is executed after the update in S130, a latest connection status of the device 20 to the device management system 30 is displayed on the device management page. On the other hand, when the acquisition of information from the database 33 in S103 is executed before the update in S130, the connection status of the device 20 to the device management system 30 displayed on the device management page in S107 is one before the update in S130. When noticing that there may be an error in the connection status of the device 20 to the device management system 30 displayed on the device management page, the user of the device management system 30 instructs the Web browser 40 to update the device management page with a page based on latest information. For example, when the connection status of the device 20 to the device management system 30 displayed on the device management page is an on-line status although the device 20 is powered off, the user of the device management system 30 instructs the Web browser 40 to update the device management page with a page based on latest information.

In updating of the device management page with a page based on latest information by the Web browser 40, the system 10 may first execute the same processing as in S121 to S130 to synchronize the connection status of the device 20 to the device management system 30 held in the database 33 with an actual connection status and then execute the same processing as in S102 to S107. Alternatively, in updating of the device management page with a page based on latest information by the Web browser 40, the system 10 may execute, instead of executing the same processing as in S121 to S130, the same processing as in S102 to S107 as the connection status of the device 20 to the device management system 30 already held in the database 33 remains unchanged.

As just described, when a request for data on the device management page for the device 20 is made via the Web browser 40, the system 10 updates the connection status of the device 20 to the device management system 30 held in the database 33. However, also when, except for a request for data on the device management page for the device 20, any specific request relating to the device management page for the device 20 is made via the Web browser 40, the system 10 may update the connection status of the device 20 to the device management system 30 held in the database 33.

As thus far described, when a specific request relating to a device management page is made (S101), the device management system 30 confirms the connection status of a device subject to the device management page (S122. S126, S127 or S129). Therefore, as compared to the configuration in which the connection status of a device is periodically confirmed, the possibility to reduce the number of confirmations of the connection status of the device can be increased, resulting in an increase in the possibility to reduce the amount of communication necessary for the confirmation of the connection status of the device to the device management system 30.

When a request for data on a device management page is made as an example of a specific request (S101), the device management system 30 confirms the connection status of a device subject to the device management page (S122, S126, S127 or S129) and updates the connection status held in the database 33 with the confirmed connection status (S130). Therefore, among the connection statuses held in the database 33, the connection status of the device highly likely to draw attention from the user can be synchronized with its actual connection status.

Generally, device management systems have a problem of no consideration being given to the method for confirming the connection statuses of devices to the device management systems. One of methods for confirming the connection status of a device to a device management system is a method in which the device management system periodically confirms the connection status with the device. However, the method in which the device management system periodically confirms the connection status with the device is highly likely to have a larger-than-necessary number of communications performed by the device management system to confirm the connection status with the device. Therefore, the method has a problem of a high likelihood of a larger-than-necessary accumulated amount of communication performed by the device management system to confirm the connection status with the device.

In contrast, in the above embodiment, the possibility to reduce the amount of communication necessary to confirm the connection status of the device can be increased.

While the present disclosure has been described in detail with reference to the embodiments thereof, it would be apparent to those skilled in the art the various changes and modifications may be made therein within the scope defined by the appended claims.

What is claimed is:

1. A device management system capable of managing a device, the device management system comprising a control device that includes a processor and functions, through the processor executing a control program, as:
a device management page creator that creates a device management page which is a web page for managing the device; and
a connection status confirmer that confirms a connection status of the device to the device management system,
wherein when a specific request relating to the device management page is made, the connection status confirmer confirms the connection status of the device managed by the device management page.

2. The device management system according to claim 1,
further comprising a connection status holding device that holds the connection status,
wherein the specific request is a request for data on the device management page, and
when confirming the connection status, the connection status confirmer updates the connection status held in the connection status holding device with the confirmed connection status.

3. The device management system according to claim 1, wherein when a specific period of time has elapsed without receiving a request receipt notification from the device after the connection status confirmer sends a request for the connection status of the device, the connection status confirmer determines that the connection status of the device to the device management system is an off-line status.
